(19) United States
(12) Patent Application Publication
(10) Pub. No.: US 2003/0172187 A1
(43) Pub. Date: Sep. 11, 2003

(54) System and method for compressing and archiving image data and transferring the archived image data to a server

(76) Inventors: Vincent Wu, Irvine, CA (US); David J. Park, Torrance, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/201,089

(22) Filed: Jul. 23, 2002

Related U.S. Application Data
(60) Provisional application No. 60/362,879, filed on Mar. 8, 2002.

(51) Int. Cl. G06F 15/16

(52) U.S. Cl. 709/247; 709/231

(57) ABSTRACT

This invention is directed to a system and method for compressing and archiving image data and transferring the archived image data to a file server. More particularly, this invention is directed to a system and method for compressing and archiving image data received from a document reading device, such as a scanning device, and transferring the archived image data to a file transfer protocol (FTP) server via FTP.

### BACKGROUND OF THE INVENTION

This invention is directed to a system and method for archiving image data and transferring the archived image data to a server. More particularly, this invention is directed to a system and method for compressing and archiving image data received from a document reading device, such as a scanning device, and transferring the archived image data to a file transfer protocol (FTP) server via FTP.

Typically, when a user uses a scanner, copier, or other document reading device, the generated image data is saved to shared network drives to be processed further. These shared network drives are easily accessed from a Windows environment. However, non-Windows users often have problems accessing the data in the shared network drives and have to go through a cumbersome process to move the data to a local workstation after the data is generated. For example, if a user wants to send the image data to a remote FTP server by FTP, the user needs to move the data to a device that has the FTP capability and send the data to the FTP server. Further, a user may need to install an application or spend additional time configuring his workstation or device in order to access the data.

There is a need for a system and method for which provides easier archiving and transferring of image data to a server, easier access to the image data by Window users and non-Windows users, and which increases use of the document reading device and the productivity of the user.

### SUMMARY OF THE INVENTION

In accordance with the present invention, there is provided a system and method which provides easier archiving and transferring of image data to a file server and easier access to image data by Windows users and non-Windows users.

Further in accordance with the present invention, there is provided a system and method for archiving and transferring image data to a server which increases the use of the document reading device and the productivity of the user.

Still further, in accordance with the present invention, there is provided a system and method for archiving and transferring image data which allows for allows the user to backup all image data stored on shared network drives.

Still further, in accordance with the present invention, there is provided a system for archiving image data received from a document reading device and transferring the archived image data to a file server. The system comprises means adapted for receiving image data from an associated document reading device. The system also comprises means adapted for selecting an associated data transfer signal, the data transfer signal including data representative of at least one selected data transfer format and a data transfer target. The system further comprises means for compressing and archiving the image data and means adapted for transmitting the archived image data via a data transfer system from an associated document reading device to an associated file server in accordance with the data transfer selection signal.

Still further in accordance with the present invention, there is provided a method for archiving image data received from a document reading device and transferring the archived image data to a file server. The method comprises receiving image data from an associated document reading device. The method further comprises selecting an associated data transfer signal, the data transfer signal including data representative of at least one selected data transfer format and a data transfer target. The method also comprises compressing and archiving the image data and transmitting the archived image data via a data transfer system from an associated document reading device to an associated file server in accordance with the data transfer selection signal.

Advantages of the system and method of the present invention, include, but are not limited to, the ability to easily transfer image data between a document reading device and a file server, the ability for Windows users and non-Windows users to easily access the image data, an increase in the usage of the document reading device and the productivity of the user, and ability to backup all image data stored on shared network drives.

These and other advantages, aspects, and features will be understood by one of ordinary skill in the art upon reading and understanding the specification.

### BRIEF DESCRIPTION OF THE DRAWINGS

FIG. 1 is a block diagram illustrating the preferred embodiment of the system according to the present invention.

FIG. 2 shows a sample template for selecting the desired data transfer signal for transmitting the generated image data to the file server.

FIG. 3 is a sample screen that shows the status of the transfer of the image data.

### DETAILED DESCRIPTION OF THE PREFERRED EMBODIMENT

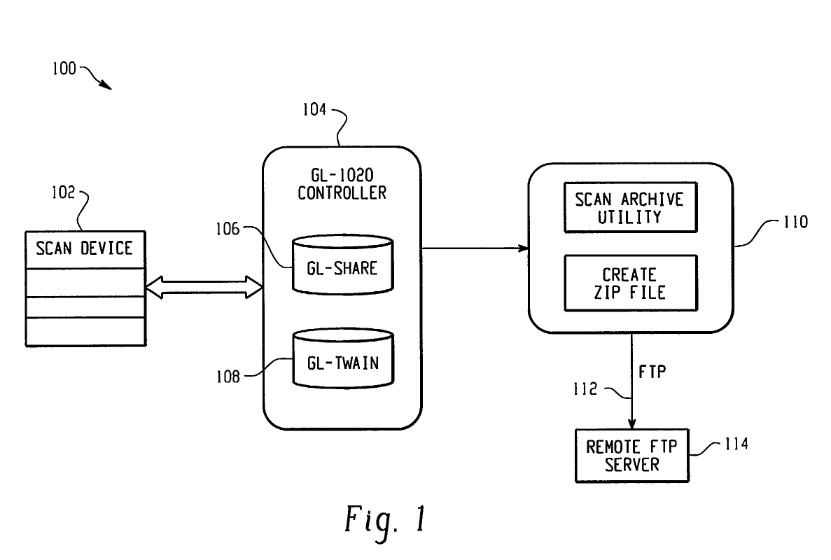

The present invention is directed to a system and method for transferring image data from a document reading device to a file server. FIG. 1 shows a block diagram preferred embodiment of the system according to the present invention generally designated as 100. The system comprises a document reading device 102, such as a scanner or copier, for generating image data. The document reading device is any suitable document reading device known in the art. Preferably, the document reading device is a scanning device, a copying device, and an optical character recognition device. More preferably, the document reading device is a scanning device. Suitable commercially available document reading devices include, but are not limited to, Toshiba e-Studio Series controller.

The document reading device further comprises a controller 104 which controls the functions of the document reading device and includes storage means for storing the image data. The controller has two storage units which are labeled in FIG. 1 as GL-Share 106 and GL-Twain 108.

In operation, the user inputs the document or other data into the document reading device to generate the image data. An Archive Utility 110 is used to access the image data on the controller. An data transfer session is initiated on the communication link 112 to the remote file server 114 whereupon the image data is transferred to the remote file server via a data transfer system. The communication link is comprised of one or more segments of wired or wireless communications. Suitable communications link include, but are not limited to, FTPLIB-3.1. In a preferred embodiment, the file server is an FTP server and the data transfer system is FTP. Preferably, the data transfer is completed on an system operating under Linux or Unix.

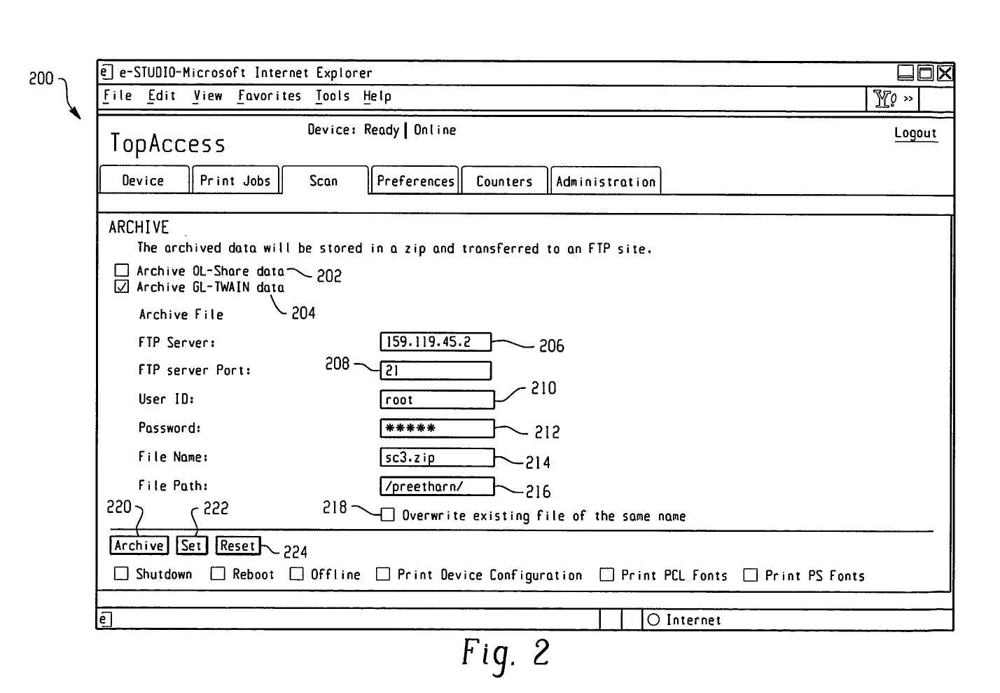

A preferred sample screen display 200 for selecting the desired agent and associated data transfer signal is shown in FIG. 2. The user first selects whether the data to be compressed, archived, and transferred is GL-Share data shown as 202, GL-Twain data shown as 204, or both. Typically there are two types of image data stored on the controller, which are Twain (GL-Twain) and Share (GL-Share) image data. The user can specify the preference of data that needs to be transferred to the server.

The user then specifies the file server 206 and the file server port 208 to which the image data is to be transferred. The user then inputs his user identification on the server account 210, password on the server account 212. The user next inputs the file name 214 and the file path 216 for the compressed file which is to be stored on the server. Additionally, a checkbox 218 enables the user to automatically overwrite an existing file on the server having the same file name.

There are three pushbuttons 220, 222, and 224 shown in FIG. 2 which are for initiating an action. Selecting the Archive button 220 causes the current settings to be saved and initiates the process of saving the image data onto the server. Selecting the Set button 222 causes the currently displayed settings to be saved in the controller. Selecting the Reset 224 button causes any new displayed settings to be erased and the old settings to be displayed.

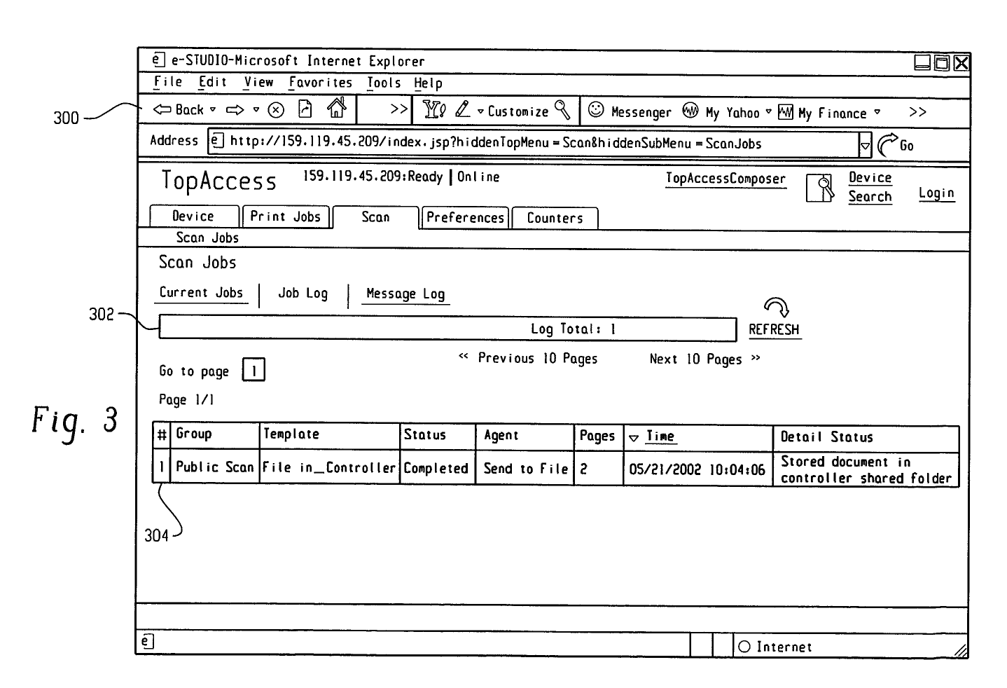

Upon selecting the Archive button, the controller 104 begins the process of transferring the image data to the file server. In one embodiment, the status of the job is provided by a sample status screen as shown in FIG. 3 as 300. The job log is shown as 302 and the status of a particular job is shown as 304.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A system for archiving image data received from a document reading device and transferring the archived image data to a server comprising:
means adapted for receiving image data from an associated document reading device;
means adapted for selecting an associated data transfer signal, the data transfer signal including data representative of at least one selected data transfer format and a data transfer target;
means adapted for compressing and archiving the image data; and
means adapted for transmitting the image data via a data transfer system from an associated document reading device to an associated server in accordance with the data transfer selection signal.

2. The system according to claim 1 comprising means adapted for transmitting image data from the document reading device to a document reading device controller in accordance with the data transfer signal and means adapted for transmitting the image data from the document reading device controller to the server in accordance with the data transfer signal.

3. The system according to claim 2 wherein the document reading device controller compresses the image data into a zip file.

4. The system according to claim 1 further comprising means adapted for selecting parameters for generating the image data.

5. The system according to claim 1 wherein the server is a file server.

6. The system according to claim 5 wherein the file server is a file transfer protocol server.

7. The system according to claim 1 wherein the data transfer system is file transfer protocol.

8. The system according to claim 1 wherein the document reading device is selected from the group consisting of an image scanning device and an optical character recognition device.

9. The system according to claim 1 wherein the data transfer is completed on an system operating under Linux or Unix.

10. A method for archiving image data received from a document reading device and transferring the image data to a server comprising:
receiving image data from an associated document reading device;
selecting an associated data transfer signal, the data transfer signal including data representative of at least one selected data transfer format and a data transfer target;
compressing and archiving the image data; and
transmitting the archived image data via a data transfer system from an associated document reading device to an associated server in accordance with the data transfer selection signal.

11. The method according to claim 10 further comprising transmitting image data from the document reading device to a document reading device controller in accordance with the data transfer signal and transmitting the image data from the document reading device controller to the server in accordance with the data transfer signal.

12. The method according to claim 11 wherein the document reading device controller compresses the image data into a zip file.

13. The method according to claim 10 further comprising selecting parameters for generating the image data.

14. The method according to claim 10 wherein the server is a file server.

15. The method according to claim 14 wherein the file server is a file transfer protocol server.

16. The method according to claim 10 wherein the data transfer system is file transfer protocol.

17. The method according to claim 10 wherein the document reading device is selected from the group consisting of an image scanning device and an optical character recognition device.

18. The method according to claim 11 wherein the data transfer is completed on an system operating under Linux or Unix.

19. A computer readable medium of instructions for archiving image data received from a document reading device and transferring the archived image data to a server comprising:
means adapted for receiving image data from an associated document reading device;
means adapted for selecting an associated data transfer signal, the data transfer signal including data representative of at least one selected data transfer format and a data transfer target;
means adapted for compressing and archiving the image data; and
means adapted for transmitting the archived image data via a data transfer system from an associated document reading device to an associated server in accordance with the data transfer selection signal.

20. The computer readable medium according to claim 19 comprising means adapted for transmitting image data from the document reading device to a document reading device controller in accordance with the data transfer signal and means adapted for transmitting the image data from the document reading device controller to the server in accordance with the data transfer signal.

21. The computer readable medium according to claim 19 wherein the server is a file transfer protocol server.

22. The computer readable medium according to claim 19 wherein the data transfer system is file transfer protocol.

23. The computer readable medium according to claim 19 wherein the document reading device is selected from the group consisting of an image scanning device and an optical character recognition device.

24. A computer-implemented method for archiving image data received from a document reading device and transferring the archived image data to a server comprising:
receiving image data from an associated document reading device;
selecting an associated data transfer signal, the data transfer signal including data representative of at least one selected data transfer format and a data transfer target;
compressing and archiving the image data; and
transmitting the archived image data via a data transfer system from an associated document reading device to an associated server in accordance with the data transfer selection signal.

25. The computer-implemented method according to claim 24 comprising means adapted for transmitting image data from the document reading device to a document reading device controller in accordance with the data transfer signal and means adapted for transmitting the image data from the document reading device controller to the server in accordance with the data transfer signal.

26. The computer-implemented method according to claim 24 wherein the server is a file transfer protocol server.

27. The computer-implemented method according to claim 24 wherein the data transfer system is file transfer protocol.

28. The computer-implemented method according to claim 24 wherein the document reading device is selected from the group consisting of an image scanning device and an optical character recognition device.
